(19) United States
(12) Patent Application Publication
(10) Pub. No.: US 2025/0286955 A1
(43) Pub. Date: Sep. 11, 2025

(54) CLOUD-BASED DEPLOYMENT OF COMMUNICATION SERVICES

(71) Applicant: G.S. CONSULTING & RESEARCH CORRENET LTD, Nes Ziona (IL)

(72) Inventors: Gonen Sagie, Karmei Yosef (IL); Shirin Yonatani, Rishon LeZion (IL)

(21) Appl. No.: 18/783,829

(22) Filed: Jul. 25, 2024

Related U.S. Application Data
(60) Provisional application No. 63/562,405, filed on Mar. 7, 2024.

(51) Int. Cl. H04M 7/00; H04Q 3/00

(52) U.S. Cl. CPC H04M 7/0081; H04M 7/009; H04Q 3/0045

(57) ABSTRACT

A method, apparatus and computer program product for determining a plan of a first migration phase for a source to target telephony migration in at least two phases, the method comprising: obtaining a configuration of the source system including devices and users entities, each associated with attributes and values; generating a graph from the configuration, each node represents a source entity, nodes having corresponding attribute values are connected; obtaining a threshold number of entities for migrating on the first phase; determining a cluster of nodes, comprising determining a first and second maximal density clusters having first and second densities and cluster sizes not exceeding the threshold; and selecting the first or second clusters; adding to the first phase plan entities represented by the selected cluster; and providing the plan to a coordinator, whereby enabling execution of the first phase, whereby a hybrid system is operated, comprising the source and target.

### CROSS-REFERENCE TO RELATED APPLICATION

This application claims the benefit of provisional patent application No. 63/562,405, entitled “CLOUD-BASED DEPLOYMENT OF COMMUNICATION SERVICES” filed Mar. 7, 2024, which is hereby incorporated by reference in its entirety without giving rise to disavowment.

### TECHNICAL FIELD

The disclosure generally relates to the field of providing communication services, and specifically to migrating a telephony system of an organization from an at least partially on-premise system to cloud-based service.

### BACKGROUND

A communication system, including a telephony system is one of the most significant backbones of many organizations, such as commercial companies, educational institutes, banks, government offices, NGOs, or others. In the last decades, a significant part of the communication volume is carried out using Voice over Internet Protocol (VOIP). The term VOIP generally refers to methods and technologies for the delivery of voice communications and multimedia sessions over Internet Protocol (IP) networks, such as the Internet. VoIP refers to the provisioning of communications services, such as but not limited to voice, voice-messaging, texts, or others over the Internet.

Many organizations use communication networks comprising on-premise physical telephony systems, whether private exchange branches (PBXs) or VOIP systems. An on-premise phone system is generally a tangible installation of telephones in a workplace. However, more and more organizations shift to modern cloud-based networks, due to the many significant advantages they offer.

First, installing an on-premise telephony system can span over up to several months. Depending on the scale of the operation, hardware needs to be purchased and manually configured to establish the infrastructure for the setup. Moreover, the equipment requires dedicated space, and also incurs maintenance costs. Cloud-based systems, however, can be set up by one person downloading and executing the relevant software, without any special equipment that needs to be purchased and maintained

Moreover, the cost of on-premise setup depends on the size of the system, and therefore increases with the number of users and devices, sometimes holding back the growth of the business. Setting up a cloud-based system, on the other hand, does not require heavy expenses and almost no installation costs are associated.

Moreover, the installation ease also provides for almost effortless scalability, including upscale and downscale, for example as required by seasonal businesses. The payment is proportional to the used services, and no sunk cost is involved.

Cloud-based systems are also more reliable, as no tangible breakable on-premise equipment is involved, while the servers are maintained by the service provider as part of the service.

Cloud based systems allow for a richer variety of options to the users which can also be supplemented over time, and easy integration with other systems such as accounting systems, customer service systems, or others, which can be helpful to the organization as well as to their customers.

Cloud-based systems provide for easier compliance with government regulations, and last but not least, offer better security against malicious and occasional threats.

Despite the advantages above, migrating an organization from on-premise telephony system to a cloud-based system may pose some challenges. The challenges may become harder as the number of users and devices in the organization increases, and in particular when not all users can be migrated at once.

### BRIEF SUMMARY

One exemplary embodiment of the disclosed subject matter is a method for determining a migration plan of a first migration phase for a source telephony system to a target telephony system, wherein the source telephony system is to be migrated in two or more migration phases, the method comprising: obtaining a configuration of the source telephony system, the configuration comprises information about entities in the source telephony system, wherein for each entity of the entities, the configuration indicates one or more attributes and values thereof, wherein the entities comprise devices and users; generating an entities graph based on the configuration, the entities graph comprising nodes and edges, each node of the nodes represents an entity of the source telephony system, each two nodes of the nodes that represent two corresponding entities that have corresponding values for at least one attribute are connected by an edge; obtaining a threshold on a number of entities to be migrated to the target telephony system during the first migration phase; determining, based on the entities graph, a cluster of nodes, wherein said determining the cluster of nodes comprises: determining a first maximal density cluster in the entities graph for a first cluster size, the first cluster size not exceeding the threshold, the first maximal density cluster having a first density level; determining a second maximal density cluster in the entities graph for a second cluster size, the second cluster size not exceeding the threshold, the second maximal density cluster having a second density level; and selecting the cluster of nodes between the first maximal density cluster and the second maximal density cluster, wherein said selecting is performed based on the first cluster size, the second cluster size, the first density level and the second density level; adding to the migration plan of the first migration phase entities represented by nodes included in the cluster of nodes; and providing the migration plan to a migration coordinator, whereby enabling execution of the first migration phase, whereby a hybrid telephony system is operated, the hybrid telephony system comprises the source telephony system and the target telephony system. The method can further comprise: removing from the entities graph nodes comprised in the cluster, whereby obtaining a reduced entities graph; subject to the reduced entities graph comprising more nodes than the threshold, repeating said determining the cluster of nodes and said removing with respect to the reduced entities graph to obtain at least one second cluster; and determining at least one additional migration plan for at least one additional migration phase, wherein each at least one additional migration plan corresponds to one of the at least one second cluster or to a last obtained reduced entities graph. The method can further comprise: identifying an entity pair that is characterized in a first entity of the entity pair representing a first node included in the cluster of nodes and a second entity of the entity pair representing a second node not included in the cluster of nodes; and outputting the entity pair to the migration coordinator, whereby notifying the migration coordinator about entities who are expected to have a reduced functionality in the hybrid telephony system. The method can further comprise: receiving instructions from the migration coordinator regarding the entity pair. Within the method, an attribute of the one or more attributes is optionally a shared line. Within the method, an attribute of the one or more attributes is optionally an association with a hunt group. Within the method, an attribute of the one or more attributes is optionally is related to a speed dial feature. Within the method, the first migration phase is optionally to be started and completed over a weekend. Within the method, determining the first maximal density cluster is optionally performed using a dense K subgraph (DKS) algorithm. The method can further comprise: scheduling a cluster migration for the cluster of nodes and at least one second cluster, the at least one second cluster having a number of entities not exceeding the threshold; and automatically migrating the cluster of nodes and one or more second clusters. Within the method, the source telephony system is optionally an IP system or a Private Branch Exchange (PBX) system. Within the method, the source telephony system is optionally at least partially on-premise. Within the method, the target telephony system is optionally a cloud telephony system.

Another exemplary embodiment of the disclosed subject matter is a computerized apparatus having a processor, for determining a migration plan of a first migration phase for a source telephony system to a target telephony system, wherein the source telephony system is to be migrated in at least two migration phases, the processor being configured to perform: obtaining a configuration of the source telephony system, the configuration comprises information about entities in the source telephony system, wherein for each entity of the entities, the configuration indicates one or more attributes and values thereof, wherein the entities comprise devices and users; generating an entities graph based on the configuration, the entities graph comprising nodes and edges, each node of the nodes represents an entity of the source telephony system, each two nodes of the nodes that represent two corresponding entities that have corresponding values for at least one attribute are connected by an edge; obtaining a threshold on a number of entities to be migrated to the target telephony system during the first migration phase; determining, based on the entities graph, a cluster of nodes, wherein said determining the cluster of nodes comprises: determining a first maximal density cluster in the entities graph for a first cluster size, the first cluster size not exceeding the threshold, the first maximal density cluster having a first density level; determining a second maximal density cluster in the entities graph for a second cluster size, the second cluster size not exceeding the threshold, the second maximal density cluster having a second density level; and selecting the cluster of nodes between the first maximal density cluster and the second maximal density cluster, wherein said selecting is performed based on the first cluster size, the second cluster size, the first density level and the second density level; adding to the migration plan of the first migration phase entities represented by nodes included in the cluster of nodes; and providing the migration plan to a migration coordinator, whereby enabling execution of the first migration phase, whereby a hybrid telephony system is operated, the hybrid telephony system comprises the source telephony system and the target telephony system. Within the computerized apparatus, the processor is optionally further configured to perform: removing from the entities graph nodes comprised in the cluster, whereby obtaining a reduced entities graph; subject to the reduced entities graph comprising more nodes than the threshold, repeating said determining the cluster of nodes and said removing with respect to the reduced entities graph to obtain at least one second cluster; and determining at least one additional migration plan for at least one additional migration phase, wherein each at least one additional migration plan corresponds to one of the at least one second cluster or to a last obtained reduced entities graph. Within the computerized apparatus, the processor is further configured to perform: identifying an entity pair that is characterized in a first entity of the entity pair representing a first node included in the cluster of nodes and a second entity of the entity pair representing a second node not included in the cluster of nodes; and outputting the entity pair to the migration coordinator, whereby notifying the migration coordinator about entities who are expected to have a reduced functionality in the hybrid telephony system, wherein the processor is further configured to receive instructions from the migration coordinator regarding the entity pair. Within the computerized apparatus, an attribute of the one or more attributes is optionally selected from the group consisting of: a shared line; an association with a hunt group; and a speed dial feature. Within the computerized apparatus, the source telephony system is optionally an IP system or a Private Branch Exchange (PBX) system. Within the computerized apparatus, the source telephony system is optionally at least partially on-premise and the target telephony system is a cloud telephony system.

Yet another exemplary embodiment of the disclosed subject matter is a computer program product comprising a non-transitory computer readable storage medium retaining program instructions, which program instructions when read by a processor, cause the processor to determine a migration plan of a first migration phase for a source telephony system to a target telephony system, wherein the source telephony system is to be migrated in at least two migration phases, the instructions comprising: obtaining a configuration of the source telephony system, the configuration comprises information about entities in the source telephony system, wherein for each entity of the entities, the configuration indicates one or more attributes and values thereof, wherein the entities comprise devices and users; generating an entities graph based on the configuration, the entities graph comprising nodes and edges, each node of the nodes represents an entity of the source telephony system, each two nodes of the nodes that represent two corresponding entities that have corresponding values for at least one attribute are connected by an edge; obtaining a threshold on a number of entities to be migrated to the target telephony system during the first migration phase; determining, based on the entities graph, a cluster of nodes, wherein said determining the cluster of nodes comprises: determining a first maximal density cluster in the entities graph for a first cluster size, the first cluster size not exceeding the threshold, the first maximal density cluster having a first density level; determining a second maximal density cluster in the entities graph for a second cluster size, the second cluster size not exceeding the threshold, the second maximal density cluster having a second density level; and selecting the cluster of nodes between the first maximal density cluster and the second maximal density cluster, wherein said selecting is performed based on the first cluster size, the second cluster size, the first density level and the second density level; adding to the migration plan of the first migration phase entities represented by nodes included in the cluster of nodes; and providing the migration plan to a migration coordinator, whereby enabling execution of the first migration phase, whereby a hybrid telephony system is operated, the hybrid telephony system comprises the source telephony system and the target telephony system.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic illustration of an exemplary on-premise telephony system, in accordance with some exemplary embodiments of the disclosure;

FIG. 2 is a schematic illustration of an exemplary cloud-based telephony system, in accordance with some exemplary embodiments of the disclosure;

FIG. 3 is a flowchart of steps in a method for determining, scheduling and applying a migration plan for an organization, in accordance with some exemplary embodiments of the disclosure;

FIG. 4 is an exemplary representation of a graph, in accordance with some exemplary embodiments of the disclosure;

FIG. 5 shows the graph of FIG. 4 and the densest cluster of size 10, in accordance with some exemplary embodiments of the disclosure;

FIG. 6 shows a reduced graph, in accordance with some exemplary embodiments of the disclosure; and

FIG. 7 shows a block diagram of a system for determining, scheduling and applying a migration plan for an organization, in accordance with some exemplary embodiments of the disclosure.

### DETAILED DESCRIPTION

One technical problem dealt with by the disclosed subject matter is to enable efficient migration of an organization from a physical on-premise switchbox, such as private exchange switchbox (PBX) or on-premise Voice over IP (VOIP) system to a cloud-based service.

In order to eliminate or minimize down time of the organization, migration is typically performed during off hours, for example started and completed over a weekend.

For easy and smooth migration, it is required that the migration maintains the attributes and options available to each human user and each device (collectively referred to as users).

For small organizations, such as organizations of up to about 500 users, the migration may be performed at once, thus maintaining all attributes and associations.

However, for larger organizations, this may not be possible, and thus migration may need to be spread over a number of phases, such that some of the users are migrated on each phase, wherein the number of users that can be migrated at each phase is limited by the time window available for the phase. This split into phases may present a problem of breaking existing associations between users, such that some functionality of some of the users may be unavailable during the transition time.

One example of such association relates to a group of users referred to as a hunt group, where incoming calls made to a single number are re-routed to multiple phone lines and distributed to a group of people, such that the call may reach any one of the people in the group. Common uses include sales teams, customer support teams, or the like.

If a hunt group is spread over two or more physical locations, and the users in each location are migrated at a different phase, there will be a time gap during which the hunt group will not be able to function as expected.

Another example relates to one person controlling incoming and sometime outgoing calls of another, such as a boss-secretary arrangement. Thus, if the phone of a boss is migrated while the secretary is not, or the other way around, the shared line will not work, thus harming the workflow.

Yet another example relates to local or organizational speed dials. Speed dial may relate to two or more users sharing the same speed dial configurations in calling other numbers. Additionally, speed dial may relate to users within a same site or within a same organizational unit which may disperse over multiple geographic areas, being able to dial to each other using only a few digit extension, users in a same country not having to enter the country code when calling each other, or the like.

If some of the users that share speed dial configurations are migrated while others are not, the speed dial may not work, thus again, harming the workflow. Additionally, or alternatively, in some cases, in order for a first user to speed dial a second user, they may need to be in a same telephony system (e.g., IP/PBX).

Yet another example relates to conference-room phones, which are not associated with a specific human user but may be associated with a department, a floor, a site, or the like. Such device may be required to be migrated together with one or more users, such as users working in nearby offices, users associated with a same organization unit as the phone, or the like.

Thus, if a migrating organization, or even a migrating sub-group of an organization contains more than the number of users that can be migrated on a single phase, some associations (also referred to as connections) between users, stemming for example from shared or corresponding attributes will probably be broken.

Therefore, in order not to harm the workflow within a migrating organization, it is required to determine a division of the users into clusters, wherein as much as possible of the attribute values shared between users are intra-cluster, and wherein the users within each cluster can be migrated at a same phase, thereby minimizing the breaking of such associations.

Another technical problem is the need to ensure that the size of each such cluster is limited by the number of users which may be migrated in a given phase, such as a over a weekend.

Yet another technical problem dealt with by the disclosed subject matter relates to the need to acknowledge a person in charge, such as a migration coordinator, a system administrator, a or the like about the broken connections and associations. It may be required that the person can approve the association being broken, change the cluster association of a user by adding a user to a cluster, removing a user from a cluster, or the like.

One technical solution of the disclosure comprises creating one or more migration plans, by splitting the collection of users into clusters of size that does not exceed the number of users that can be migrated on one phase, and wherein the total intra-cluster connections are maximized, so as to minimize disruptions to the workflow of the organization.

In some exemplary embodiments, the configuration of the telephony system may be obtained from one or more configuration files, databases, or the like. The configuration may indicate a plurality of attributes and connections for each user, such as speed dials, association with a hunt group, a shared line such as in boss-secretary configuration, or the like.

A graph, implemented as any data structure, may then be generated upon the configuration. The graph may comprise a node for each user, including each human user and each line or device, such as a conference room telephone. Any two nodes having a shared attribute or another relationship as detailed above may be connected by an edge in the graph.

In some exemplary embodiments, each edge may be assigned with a weight, such that stronger relationships may have a higher weight than weaker relationships. For example, a boss-secretary relationship may have a higher weight than a same speed dial relationship. It is appreciated that two nodes may be connected by multiple edges, or by a single edge having a weight that integrates the weights of the existing connections between the nodes.

In other embodiments, any edge between two nodes may be assigned the same value, regardless of the number and type of the associations between the users represented by the nodes.

A density of a cluster of nodes may be defined as the sum or another integration of the weights of the edges connecting nodes within the cluster, relative to the total possible sum of the weights. For example, if all connections are of the same weight, for example 1, the density is the number of edges in the cluster, divided by the maximal number of edges which is N*(N−1)/2, wherein N is the number of nodes in the cluster.

It is appreciated that in the disclosure below a node in the graph is equivalent to a user, an edge is equivalent to an association between users, and a cluster in the graph is equivalent to a group of users. Thus, these term pairs are used interchangeably.

Once the graph is generated, a cluster of nodes may be detected, which has the highest density and is of size that does not exceed the maximal number of users that can be migrated on a single phase. In some exemplary embodiments, a minimal number of users in a cluster may also be enforced, in order to avoid breaking the graph into too small fragments and using the migration time window in a suboptimal manner. In some exemplary embodiments, a tradeoff may be applied between the sizes of two clusters and their densities. For example, a group that is smaller than another group by at most a predetermined number nodes (or percentage), but has a density higher in at least a predetermined value, may be preferred over the larger group with the smaller density.

The cluster may be determined as follows: starting at a minimal acceptable cluster size J, a dense K subgraph (DKS) algorithm may be applied to the graph to detect the densest cluster having a size of J. The density of the cluster may also be calculated. The process may repeat for increasing values of J until a threshold indicating the maximal number of users that may be migrated on a single phase is reached.

Once a cluster and its density are available for multiple values of J, the largest cluster, the densest cluster, or the cluster that provides the highest tradeoff between size and density may be selected.

The nodes of the cluster, and all connections within the cluster of nodes within the cluster or a node within the cluster with a node external to the cluster may be removed from consideration, and the process may repeat for detecting further clusters to be migrated on another phase.

The process may be stopped when the number of nodes remaining from the graph is lower than a minimum, when the connections between the remaining nodes are of weights below a threshold, after a predetermined number of clusters have been created, or another stopping criteria is met.

A person in charge, such as a migration coordinator, a system administrator, or the like may then be notified about one or more of the following:

The determined clusters;
Connections that are broken due to edges connecting nodes that are assigned to different clusters; and
One or more nodes that are not assigned to any cluster.

The notification may take the form of sending an e-mail, a short message, a message in a social network, updating a database, or the like.

Depending on the coordinator's discretion, broken edges may be re-instated by adding a node to a cluster, for example moving a node from one cluster to the other. This may break other connections, such as connections between the newly added node and other nodes in its original cluster. This may also create a cluster having more nodes than the threshold.

The migration coordinator may also approve one or more broken associations, or make any other change to the clustering.

Another technical solution of the disclosure is the automatic scheduling of the migration, wherein the migration phase of each cluster of users is scheduled to be occur at a certain time slot, and performing the actual migration.

One technical effect of the disclosure is the division of the users within an organization or part thereof into clusters, such that users associated with each cluster are to be migrated together.

Another technical effect of the disclosure is the enforcement of the threshold, e.g., the maximal number of users in a cluster (unless a deviation is approved by a person in charge), thereby ensuring that the cluster can be migrated on a single phase during a predetermined period of time, thereby eliminating or minimizing the downtime of the organization or part thereof.

Yet another technical effect of the disclosure is providing a notification to a migration coordinator about broken connections, such that the coordinator can decide whether to approve the broken connection, to fix it even in the price of breaking other connections, escalating the problem to another person, or the like.

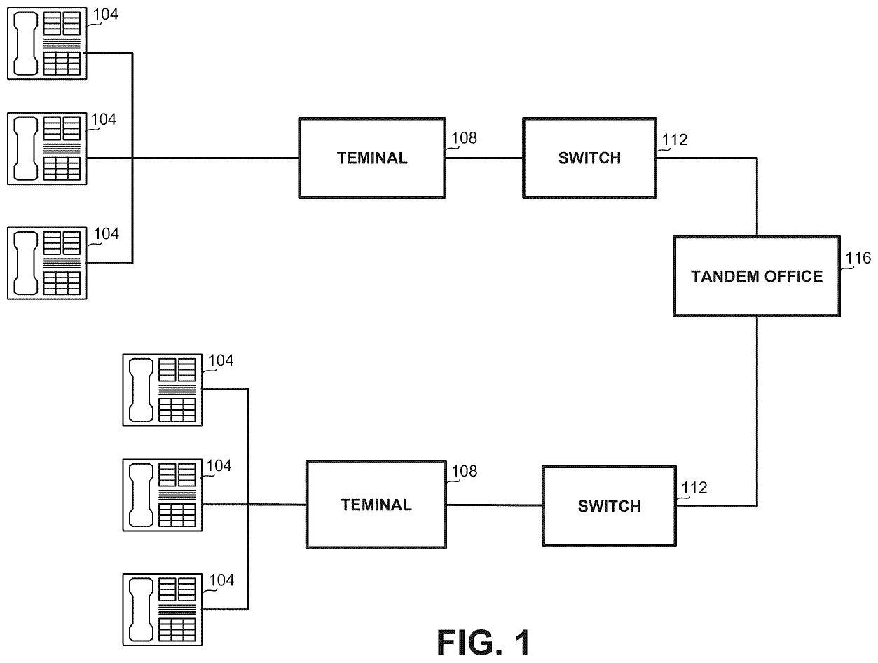

Referring now to FIG. 1, showing a schematic illustration of an exemplary on-premise telephony system, in accordance with some exemplary embodiments of the disclosure.

The system comprises a plurality of desktop phones 104. Each phone 104 may be associated with a human user, a group of users, a location such as a meeting room, or another entity in the organization. Each device 104 may also be associated with a plurality of attributes and corresponding values thereof, such as speed dial, association with a hunt group, association with another user or device, or the like.

Every group of phones, for example in a particular site, or a particular team are connected to a terminal 108, which in turn connects to switch 112.

A plurality of switches 112 are connected to tandem office 116, which is a telephone switching center (central office) that does not connect directly to the phone, but rather connects offices in the same network or between networks. Thus, tandem office 116 deals with trunks rather than customer lines.

Thus, in addition to the desktop phones 104, the system comprises a plurality of hardware units which are costly to install, configure, re-configure as required, maintain, or the like. The system also suffers from the other disadvantages mentioned above.

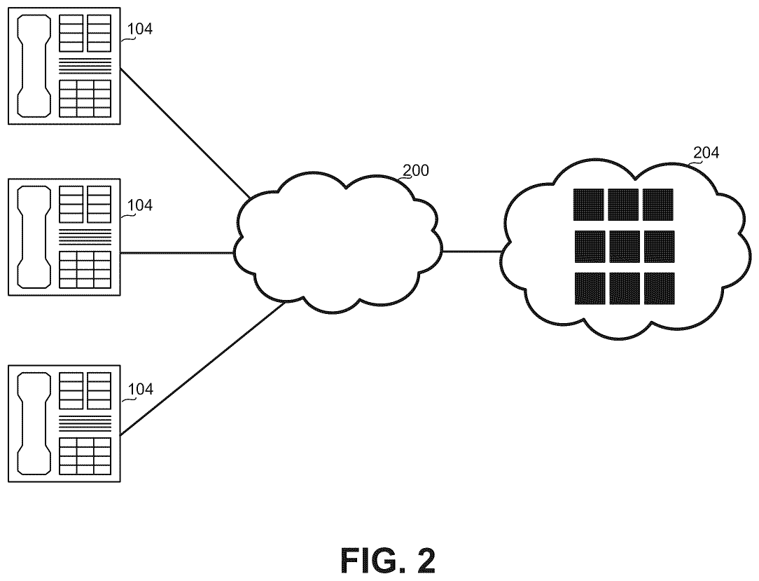

Referring now to FIG. 2, showing a schematic illustration of a cloud-based telephony system.

The system comprises desktop phones 104 as in FIG. 1. Each phone is connected to the Internet 200, as any other device in the organization, for example via Local Area Network (LAN), Wide Area Network (WAN), or the like.

Internet 204 connects each phone 104 to a cloud service provide 204, which supports all the attributes associated with phone 104. Thus, the system requires no additional resources beyond Internet access, therefore enabling easy installation, configuration, re-configuration and no particular maintenance. In addition, the system provides for enhanced security, easier compliance with government regulations, and easy integration with other systems, such as third party systems.

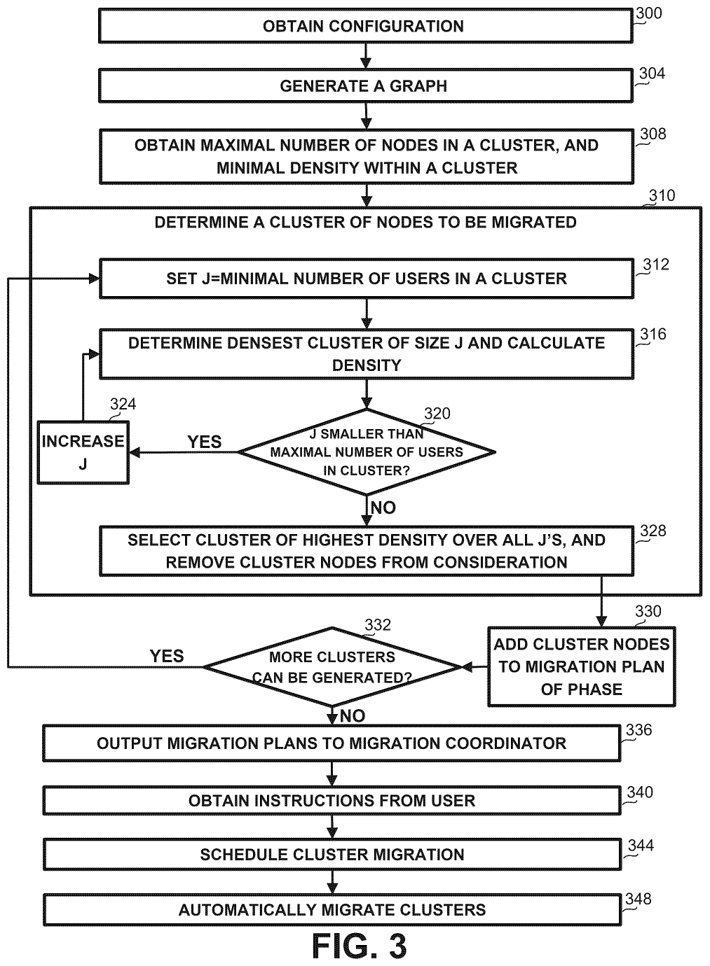

Referring now to FIG. 3, showing a flowchart of steps in a method for determining, scheduling and applying at least one migration plan for an organization, in accordance with some exemplary embodiments of the disclosure.

The method may be applicable to migrating an organization employing a source telephony system, which may be an IP or a PBX system and which may be at least partially on-premise, into a target telephony system, which may be a telephony system implemented on a cloud. The telephony system includes entities, being users and/or devices. Due to limitations on the number of entities that can be migrated at once, the migration may be divided into at least two phases, wherein between the two phases the system needs to remain operative as a hybrid system, even of not all the functionality is maintained. xx

At step 300, a configuration of the source telephony system may be obtained. The configuration may describe the telephony system, including information about the entities, and attributes and values available for each user and device. In some embodiments, the configuration may be obtained from one or more files which may be in any acceptable format. The configuration may be retrieved from a storage device, received over a communication network, or the like.

At step 304, an entity graph representing the telephony system may be generated upon the obtained configuration. In some embodiments, the data structure may be a graph, and the disclosure below uses the terms graph and data structure interchangeably. However, it is appreciated that the graph may be implemented using any required data structure.

The graph may comprise nodes, such that each node in the graph may represent an entity in the telephony system. Two nodes associated with users that have corresponding values for an attribute such as speed dial, are members of the same group such as a hunt group, have a shared line, or the like, are connected by an edge.

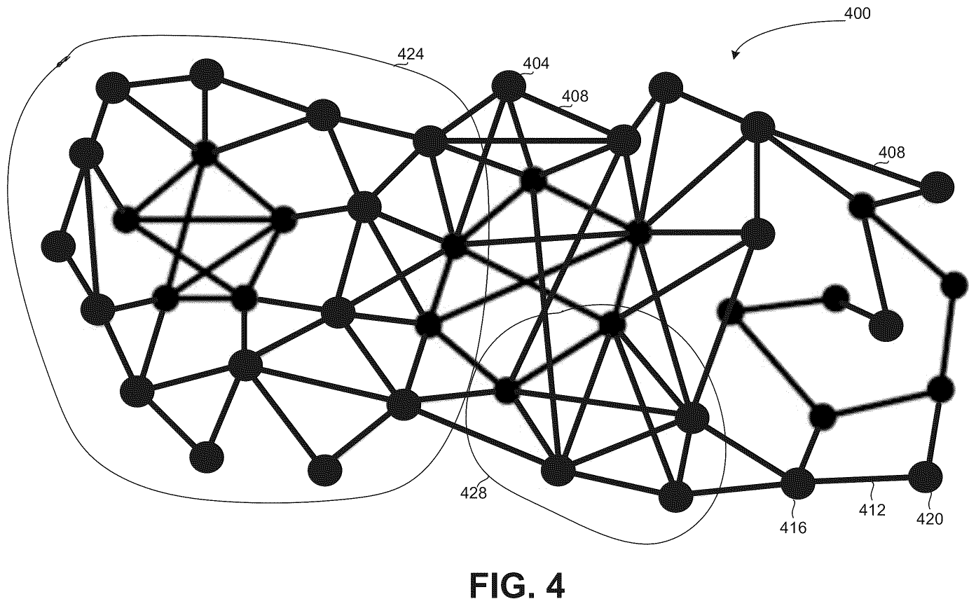

FIG. 4 shows an exemplary representation of a graph, in accordance with some exemplary embodiments of the disclosure. Graph 400 comprises multiple nodes such as nodes 404, each associated with an entity, and a plurality of edges 408 indicating connections between the two nodes at its ends.

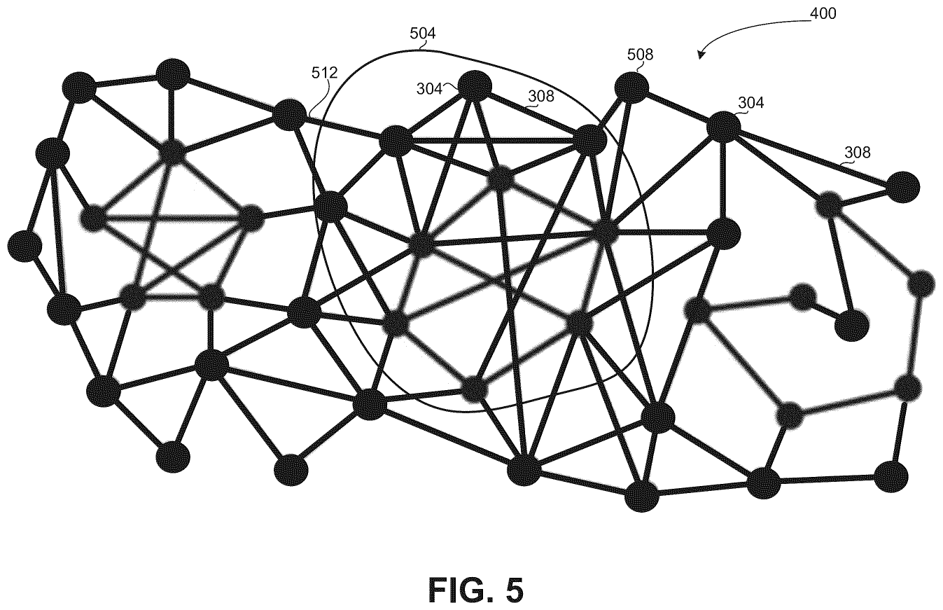

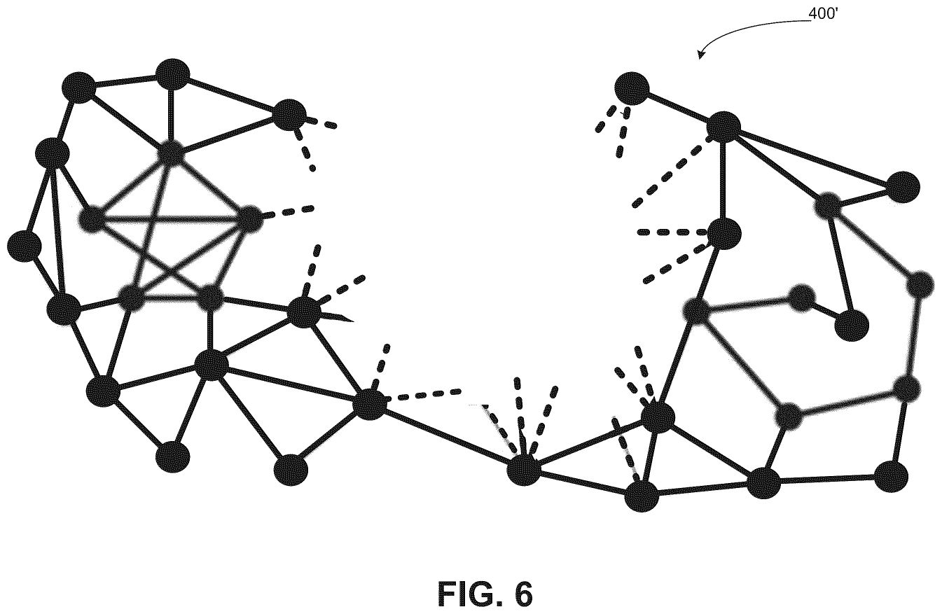

It is appreciated that although the graph may be represented visually as shown in FIG. 4 and also on FIGS. 5-6 below, this is merely a schematic two-dimensional representation and is shown for explanation purposes, while the graph is abstract and may be implemented in a plurality of data structures.

The graph may comprise edges of multiple types, for example, edge 412 may connect node 416 and node 420, wherein nodes 416 and 420 represent human users, and wherein the user of node 416 is the secretary of the user of node 420.

Similarly, the nodes within area 424 may all be within the same site and thus share speed dial options, and the nodes within area 428 may all belong to a same hunt group.

In some exemplary embodiments, each type of edge, such as an edge associated with membership in a group, an edge associated with a shared line, an edge associated with a same speed dial, or others, may have a weight. Thus, the total weight of a connection between two nodes may be an integration, for example a sum of the weights of the edges connecting the nodes.

In other exemplary embodiments, once there is any edge between two nodes, the connection may be considered to have a predetermined weight, such as 1.

In some embodiments, attributes shared by the whole organization may be ignored as they imply an edge between any two nodes within the graph, therefore some of them may have to be broken in any division, and they may also be weaker than more specific connections.

At step 308, a threshold, e.g., a maximal number of nodes in a cluster may be obtained. The number may represent the maximal number of users that can be migrated within a single phase, such as a first phase, for example over a weekend. In some embodiments, a minimal number of nodes in a cluster may also be obtained. A minimal density of a cluster may also be obtained, for example the number of edges out of the total number of possible edges (which is N*(N−1)/2) where N is the size of the cluster. The density may be calculated in a different manner if edges are assigned different weights. For example, the weight of a connection between two users may be the sum of the weights of the different associations therebetween, and optionally capped by a predetermined number.

At step 310, a cluster of nodes to be migrated in a single migration phase may be determined based upon the entities graph. Determining the cluster may comprise determining for each of a plurality of cluster sizes not exceeding the threshold, the maximal density cluster having the cluster size, and then selecting among the maximal density clusters.

Thus, at step 312, a variable J may be set to a value of the minimal number of nodes in the cluster. If no such minimal value is obtained, J may be initially set to 2.

At step 316, the densest cluster in the graph having a size of J, i.e., the maximal density cluster having size J, may be determined. In some exemplary embodiments, the cluster may be determined using the DKS algorithm with K equal to J, yielding the densest cluster of size J. Unless the density calculation is part of the cluster determination, the density of the cluster may then be calculated based on the number and optionally weight of the edges within the cluster.

Referring now to FIG. 5, showing graph 400 and the densest cluster of size 10, which comprises the nodes within area 504, in accordance with some exemplary embodiments of the disclosure.

In some exemplary embodiments, if the density of the densest cluster is below the threshold, no cluster is generated.

At step 320 it may be determined whether J is smaller than the maximal number of users in the cluster, as obtained at step 308.

If J is smaller than the maximal number, then at step 324 J may be increased by 1 or more, depending for example on the difference between J and the threshold.

The process may then continue with determining the densest cluster for the new value of J, followed by calculating the density of the cluster (unless such calculation is a part of the cluster determination). In the example of FIG. 5, suppose that the densest cluster of size 11 comprises the nodes of cluster 504 and additional node 508.

If J is equal to the maximal number of nodes in the cluster, then at step 328 a cluster may be selected from the maximal density clusters determined for each value of J. The cluster may be selected based on the sizes of the clusters determined for the different values of J, and the corresponding density levels.

In the example of FIG. 5, node 508 when adjoined to the cluster comprising the nodes of area 504, may decrease the overall density of the cluster, depending on the details of the calculation in the specific implementation. Thus, in such case the selected cluster may comprise only the modes of area 504. In another example, the selected cluster may be determined as the nodes of area 504, plus node 508.

It is thus appreciated that in some embodiments, a tradeoff may be applied, such that a less dense cluster with more nodes may be selected over a denser cluster with less nodes, while in other cases the larger cluster may be preferred.

The nodes of the selected cluster, and all edges having at least one node within the cluster may then be removed from further consideration, and a reduced graph, may be obtained.

Referring now to FIG. 6, showing reduced graph 400′, which is the result of removing the nodes of cluster 504 and all associated edges from graph 400.

It is appreciated that the edges, marked as dashed lines in FIG. 6, connecting a node within cluster 504 with a node outside cluster 504, represent broken connections which should be notified to a migration coordinator or another person in charge.

At step 330, the entities associated with the nodes of the selected cluster may be added to the migration plan of the current migration phase. Once the migration plans of one or more phases are applied, a hybrid telephony system may be operated, which comprises the source telephony system and the target telephony system, wherein some nodes are operated under the source telephony system while others are operated under the target telephony system.

Then, at step 332, it may be determined whether more clusters may be determined from the remaining graph, such as graph 400′, for example whether the number of the nodes remaining for consideration exceeds the minimal number of nodes in a cluster.

If more clusters may be determined, execution may return to step 312 to determine a further cluster, after the already generated clusters have been removed from consideration.

In some embodiments, if the number of nodes remaining is lower than the threshold, all remaining nodes may be considered a cluster and added to the migration plan of another phase.

If no more clusters may be generated, then at step 336 the migration plans may be output to a migration coordinator, such as a migration officer, a system administrator, or the like.

One or more entity pairs may be identified within the graph, as marked by the broken dashed lines in FIG. 6, wherein one entity of the pair represents a first node included in any of the clusters and a second entity of the entity pair representing a second node not included in the same cluster. The entity pairs may be output to the migration coordinator, whereby notifying the migration coordinator about entities that have not being migrated with a connected entity, and may thus be expected to have reduced functionality in the hybrid telephony system.

Notification can be performed by popping a message on a user interface, sending an instant message, sending a message via e-mail or a messaging application, or the like.

At step 340, instructions may be received from the coordinator for at least one of the broken connections. For example, the instruction may be to connect one of the nodes of an edge to the cluster of the other node, in which case other connections may be broken and displayed to the person for consideration. Another instruction may be to approve the dissociation, to escalate the decision to someone else, or the like.

At step 344, a scheduling algorithm may be applied to schedule a migration phase for any of the clusters, and determine when the cluster is to be migrated, according for example to the cluster sizes, the available time slots, prioritization between clusters, or the like.

At step 348, one or more clusters may be automatically migrated, for example at a predetermined order as scheduled, by decreasing cluster size, at an arbitrary order, starting with a cluster containing a specific person or role holder, at an order set by a user, or the like. Furter clusters may then be migrated according to the time and resource considerations and limitations. Once one or more migration plans are executed, and before the migration is fully completed, the hybrid telephony system may be operated, although some functionality may be missing.

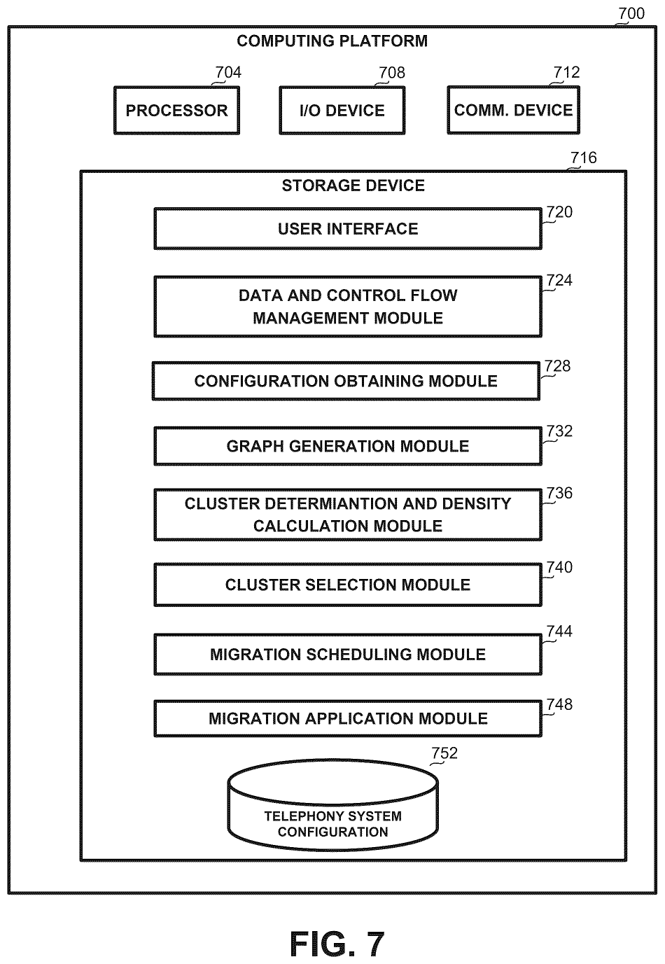

Referring now to FIG. 7, showing a block diagram of a system for block diagram of a system for determining, scheduling and applying migration plans for an organization, in accordance with some exemplary embodiments of the disclosure.

The system may comprise one or more Computing Platforms 700, which may be implemented as a stand-alone system, as part of a system implementing a telephony system, a computing platform such as a server providing services to one or more clients, or the like.

In some exemplary embodiments of the disclosed subject matter, Computing Platform 700 can comprise Processor 704. Processor 704 may be any one or more processors such as a Central Processing Unit (CPU), a microprocessor, an electronic circuit, an Integrated Circuit (IC) or the like. Processor 704 may be utilized to perform computations required by the apparatus or any of its subcomponents.

In some exemplary embodiments of the disclosed subject matter, Computing Platform 700 can comprise an Input/Output (I/O) Device 708 such as a display, a pointing device, a keyboard, a touch screen, or the like. I/O Device 708 can be utilized to receive input from a user, such as settings to be employed, and to provide output to a user, such as showing the determined clusters, dissociated users, or the like.

In some exemplary embodiments of the disclosed subject matter, Computing Platform 700 can comprise a Communication Device 712, for communicating with other computing platforms, for obtaining configurations, transmitting cluster descriptions, or the like.

Computing Platform 700 may comprise a Storage Device 716. Storage Device 716 may be a hard disk drive, a Flash disk, a Random Access Memory (RAM), a memory chip, or the like. In some exemplary embodiments, Storage Device 716 can retain program code operative to cause Processor 704 to perform acts associated with any of the subcomponents of Computing Platform 700.

Storage Device 716 can store the modules detailed below. The modules may be arranged as one or more executable files, dynamic libraries, static libraries, methods, functions, services, or the like, programmed in any programming language and under any computing environment.

Storage Device 716 may be configured to retain User Interface 720 for displaying to a user such as a migration coordinator or receiving from the user various aspects associated with the disclosure, such as displaying clusters, displaying dissociated connections, receiving input from the user such as an approval for a broken connection, or the like.

Storage Device 716 may be configured to retain Data and Control Flow Management Module 724, for managing the control and data flow within the apparatus, such that modules are invoked at the correct order and with the required information. For example, Data and Control Flow Management Module 724 can be configured to create the graph representing the telephony system, to repeatedly determine clusters and remove them from further consideration, activate the scheduling and migration, and provide output to the coordinator and receive instructions via User Interface 720.

Storage Device 716 may be configured to retain Configuration Obtaining Module 728, for obtaining one or more configuration files describing the switchboard. The configuration may be obtained from Switchboard Configuration Database 748 which may reside on Storage Device 716, or from another computing platform through Communication Device 712.

Storage Device 716 may be configured to retain Graph Generation Module 732 for generating a graph describing the telephony system including the users (human users and devices) and connections therebetween as described above.

Storage Device 716 may be configured to retain Cluster Determination and Density Calculation Module 736, for determining a densest cluster of a specific size, for example by operating the DKS algorithm on the graph, and calculating its density.

Storage Device 716 may be configured to retain Cluster Selection Module 740, configured to select from a plurality of clusters having a size not exceeding a threshold, the one that provides the best tradeoff between size and density.

It is appreciated that Data and Control Flow Management Module 724 may be configured to operate Cluster Determination and Density Calculation Module 736 with various values indicating the required size of the cluster. Data and Control Flow Management Module 724 may be further configured to repeatedly activate Cluster Determination and Density Calculation Module 736 (with various values of cluster size) and Cluster Selection Module 740, after the previously determined densest clusters have been removed from consideration.

Storage Device 716 may be configured to retain optional Migration Scheduling Module 744 for determining which cluster is to be migrated at which phase.

Storage Device 716 may be configured to retain optional Migration Activation Module 748 for migrating each cluster at the time allotted for the phase as determined by Migration Scheduling Module 240.

Storage Device 716 may be configured to retain Telephony System Configuration Database 752, comprising information about one or more telephony systems to be migrated. Telephony System Configuration Database 748 may be stored on Storage Device 716. In some embodiments, Telephony System Configuration Database 752 may be stored on a different, local or remote storage device, accessible directly or via an Application Program Interface (API).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for determining a migration plan of a first migration phase for a source telephony system to a target telephony system, wherein the source telephony system is to be migrated in at least two migration phases, the method comprising:
obtaining a configuration of the source telephony system, the configuration comprises information about entities in the source telephony system, wherein for each entity of the entities, the configuration indicates one or more attributes and values thereof, wherein the entities comprise devices and users;
generating an entities graph based on the configuration, the entities graph comprising nodes and edges, each node of the nodes represents an entity of the source telephony system, each two nodes of the nodes that represent two corresponding entities that have corresponding values for at least one attribute are connected by an edge;
obtaining a threshold on a number of entities to be migrated to the target telephony system during the first migration phase;
determining, based on the entities graph, a cluster of nodes, wherein said determining the cluster of nodes comprises:
determining a first maximal density cluster in the entities graph for a first cluster size, the first cluster size not exceeding the threshold, the first maximal density cluster having a first density level;
determining a second maximal density cluster in the entities graph for a second cluster size, the second cluster size not exceeding the threshold, the second maximal density cluster having a second density level; and
selecting the cluster of nodes between the first maximal density cluster and the second maximal density cluster, wherein said selecting is performed based on the first cluster size, the second cluster size, the first density level and the second density level;
adding to the migration plan of the first migration phase entities represented by nodes included in the cluster of nodes; and
providing the migration plan to a migration coordinator, whereby enabling execution of the first migration phase, whereby a hybrid telephony system is operated, the hybrid telephony system comprises the source telephony system and the target telephony system.

2. The method of claim 1 further comprises:
removing from the entities graph nodes comprised in the cluster, whereby obtaining a reduced entities graph;
subject to the reduced entities graph comprising more nodes than the threshold, repeating said determining the cluster of nodes and said removing with respect to the reduced entities graph to obtain at least one second cluster; and
determining at least one additional migration plan for at least one additional migration phase, wherein each at least one additional migration plan corresponds to one of the at least one second cluster or to a last obtained reduced entities graph.

3. The method of claim 1 further comprises:
identifying an entity pair that is characterized in a first entity of the entity pair representing a first node included in the cluster of nodes and a second entity of the entity pair representing a second node not included in the cluster of nodes; and
outputting the entity pair to the migration coordinator, whereby notifying the migration coordinator about entities who are expected to have a reduced functionality in the hybrid telephony system.

4. The method of claim 3, further comprising receiving instructions from the migration coordinator regarding the entity pair.

5. The method of claim 1, wherein an attribute of the one or more attributes is a shared line.

6. The method of claim 1, wherein an attribute of the one or more attributes is an association with a hunt group.

7. The method of claim 1, wherein an attribute of the one or more attributes is related to a speed dial feature.

8. The method of claim 1, wherein the first migration phase is to be started and completed over a weekend.

9. The method of claim 1, wherein determining the first maximal density cluster is performed using a dense K subgraph (DKS) algorithm.

10. The method of claim 1, further comprising:
scheduling a cluster migration for the cluster of nodes and at least one second cluster, the at least one second cluster having a number of entities not exceeding the threshold; and
automatically migrating the cluster of nodes and at least one second cluster.

11. The method of claim 1, wherein the source telephony system is an IP system or a Private Branch Exchange (PBX) system.

12. The method of claim 1, wherein the source telephony system is at least partially on-premise.

13. The method of claim 1, wherein the target telephony system is a cloud telephony system.

14. A computerized apparatus having a processor, for determining a migration plan of a first migration phase for a source telephony system to a target telephony system, wherein the source telephony system is to be migrated in at least two migration phases, the processor being configured to perform:
obtaining a configuration of the source telephony system, the configuration comprises information about entities in the source telephony system, wherein for each entity of the entities, the configuration indicates one or more attributes and values thereof, wherein the entities comprise devices and users;
generating an entities graph based on the configuration, the entities graph comprising nodes and edges, each node of the nodes represents an entity of the source telephony system, each two nodes of the nodes that represent two corresponding entities that have corresponding values for at least one attribute are connected by an edge;
obtaining a threshold on a number of entities to be migrated to the target telephony system during the first migration phase;
determining, based on the entities graph, a cluster of nodes, wherein said determining the cluster of nodes comprises:
determining a first maximal density cluster in the entities graph for a first cluster size, the first cluster size not exceeding the threshold, the first maximal density cluster having a first density level;
determining a second maximal density cluster in the entities graph for a second cluster size, the second cluster size not exceeding the threshold, the second maximal density cluster having a second density level; and
selecting the cluster of nodes between the first maximal density cluster and the second maximal density cluster, wherein said selecting is performed based on the first cluster size, the second cluster size, the first density level and the second density level;
adding to the migration plan of the first migration phase entities represented by nodes included in the cluster of nodes; and
providing the migration plan to a migration coordinator, whereby enabling execution of the first migration phase, whereby a hybrid telephony system is operated, the hybrid telephony system comprises the source telephony system and the target telephony system.

15. The computerized apparatus of claim 14, wherein the processor is further configured to perform:
removing from the entities graph nodes comprised in the cluster, whereby obtaining a reduced entities graph;
subject to the reduced entities graph comprising more nodes than the threshold, repeating said determining the cluster of nodes and said removing with respect to the reduced entities graph to obtain at least one second cluster; and
determining at least one additional migration plan for at least one additional migration phase, wherein each at least one additional migration plan corresponds to one of the at least one second cluster or to a last obtained reduced entities graph.

16. The computerized apparatus of claim 14, wherein the processor is further configured to perform:
identifying an entity pair that is characterized in a first entity of the entity pair representing a first node included in the cluster of nodes and a second entity of the entity pair representing a second node not included in the cluster of nodes; and
outputting the entity pair to the migration coordinator, whereby notifying the migration coordinator about entities who are expected to have a reduced functionality in the hybrid telephony system, wherein the processor is further configured to receive instructions from the migration coordinator regarding the entity pair.

17. The computerized apparatus of claim 14, wherein an attribute of the one or more attributes is selected from the group consisting of: a shared line; an association with a hunt group; and a speed dial feature.

18. The computerized apparatus of claim 14, wherein the source telephony system is an IP system or a Private Branch Exchange (PBX) system.

19. The computerized apparatus of claim 14, wherein the source telephony system is at least partially on-premise and the target telephony system is a cloud telephony system.

20. A computer program product comprising a non-transitory computer readable storage medium retaining program instructions, which program instructions when read by a processor, cause the processor to determine a migration plan of a first migration phase for a source telephony system to a target telephony system, wherein the source telephony system is to be migrated in at least two migration phases, the instructions comprising:
obtaining a configuration of the source telephony system, the configuration comprises information about entities in the source telephony system, wherein for each entity of the entities, the configuration indicates one or more attributes and values thereof, wherein the entities comprise devices and users;
generating an entities graph based on the configuration, the entities graph comprising nodes and edges, each node of the nodes represents an entity of the source telephony system, each two nodes of the nodes that represent two corresponding entities that have corresponding values for at least one attribute are connected by an edge;
obtaining a threshold on a number of entities to be migrated to the target telephony system during the first migration phase;
determining, based on the entities graph, a cluster of nodes, wherein said determining the cluster of nodes comprises:
determining a first maximal density cluster in the entities graph for a first cluster size, the first cluster size not exceeding the threshold, the first maximal density cluster having a first density level;
determining a second maximal density cluster in the entities graph for a second cluster size, the second cluster size not exceeding the threshold, the second maximal density cluster having a second density level; and
selecting the cluster of nodes between the first maximal density cluster and the second maximal density cluster, wherein said selecting is performed based on the first cluster size, the second cluster size, the first density level and the second density level;
adding to the migration plan of the first migration phase entities represented by nodes included in the cluster of nodes; and
providing the migration plan to a migration coordinator, whereby enabling execution of the first migration phase, whereby a hybrid telephony system is operated, the hybrid telephony system comprises the source telephony system and the target telephony system.
